(19) United States
(12) Patent Application Publication
(10) Pub. No.: US 2005/0264990 A1
(43) Pub. Date: Dec. 1, 2005

(54) Digital image viewer

(76) Inventor: James L. LaGarde, Pocomoke City, MD (US)

Correspondence Address: Raymond M. Galasso;Galasso & Associates LP, P.O. Box 26503, Austin, TX, 78755-0503, US

(21) Appl. No.: 11/117,834

(22) Filed: Apr. 29, 2005

Related U.S. Application Data
(60) Provisional application No. 60/574,284, filed on May 25, 2004.

(51) Int. Cl. G06F 1/16

(52) U.S. Cl. 361/683; 361/681; 361/680

(57) ABSTRACT

A portable digital image viewing apparatus comprises an enclosure including a first housing and a second housing that holds a visual display. The first housing contains a microprocessor and a memory module having software installed therein. A reader receives digital image data from a digital camera memory card for transfer to the microprocessor for display of the digital image on the visual display. A power supply provides power to the visual display and the microprocessor. Digital image selection and manipulation is possible using a user interface, such as a keyboard, connected to the microprocessor. A cover plate over the first housing includes a plurality of receptacles for organizing data storage components and a hinge connects the second housing to the first housing for rotation of the second housing between a closed position and an open position.

### CROSS REFERENCE TO RELATED APPLICATIONS

This patent application claims priority to co-pending U.S. Provisional Patent Application having Ser. No. 60/574,284, filed May 25, 2004, entitled “Digi Pix Portable Digital Photo Album”, having a common applicant herewith and being incorporated herein in its entirety by reference.

### FIELD OF THE DISCLOSURE

The present invention relates generally to an apparatus for reading, processing and displaying digital information corresponding to images. More specifically the present invention relates to a portable, self-contained, compact and relatively lightweight apparatus, which includes a microprocessor and appropriate software to read and display image data, stored on digital camera memory cards, or similar digital information recording media.

### BACKGROUND

The miniaturization of electronic components and related interconnecting structures provided the technical capability for producing highly versatile devices that were portable and small in size. Advances in precision engineering and digital information storage have been combined to yield sophisticated consumer electronics, one example of which is the digital camera.

Digital cameras have become popular throughout the World as convenient, versatile means for recording photographs that are immediately viewable using a built-in liquid crystal display (LCD). The feature of immediate viewing of an electronic image represents a distinct advantage over the earlier use of 35-millimeter film and other types of photographic film that incur the cost of chemical processing to produce hard-copy photographs. Images recorded with a digital camera may be easily checked via the LCD screen and re-photographed, if necessary, to correct defects in photocomposition.

While facilitating detection of poor artistic presentation and need to re-photograph a selected scene or posed group of individuals, the LCD built into a digital camera typically has such a limited size that it is unsuitable for extended viewing of a series of photos due to potential for eye-strain. The use of a personal computer overcomes the limitation of camera screen size. It is known to access digital images from recording media, used in digital cameras, by inserting the media into a memory card reader, for example, after which images stored on a memory card may be displayed on the computer monitor. Capabilities of the computer and installed software typically allow photographic images to be displayed for viewing and further manipulation including selection of images to be included with, for example, e-mail messages and for posting on web sites.

The increased size of digital photographs, viewed on a computer monitor, overcomes the problem of eyestrain associated with relatively small built-in LCD panels in digital cameras. Increased screen size also allows more convenient viewing for large numbers of digital photographs. However, there is need for further improvement for viewing images stored using a high-capacity compact disk, a portable hard drive, exemplified by “Microdrive,” available from IBM Corporation, or a memory card, which may also be referred to as a memory stick. Present-day digital cameras utilize memory cards extensively. Computer access to information from these storage media requires completion of the computer start-up procedure and selection of a program for image viewing and manipulation before display of even one photograph is possible. Another drawback of personal computers for viewing digital images concerns the need to provide image-viewing capability for several people simultaneously.

The use of desktop PCs, as digital image viewers, is often inconvenient due to both the location of the computer or the crowding of interested viewers around a monitor that has limited movement. Sharing of laptop computers among several people may be easier to accomplish but start up procedures still require completion prior to photo-viewing. There is also the possibility that the correct input device, e.g. memory card reader, may not be installed in an available laptop unit.

Therefore, an apparatus that overcomes shortcomings associated with conventional approaches for viewing digital images would be advantageous, useful and novel.

### SUMMARY OF THE DISCLOSURE

In view of the above described deficiencies associated with respect to the conventional use of personal computers as digital image viewing devices, there is a need for a digital image viewer that allows rapid access to digital photographs while facilitating wide angle viewing by several people simultaneously. Alternatively a digital image viewer may be manufactured to a specified size and weight for portability that allows photo viewing anywhere as a shared activity among a group of individuals. The present invention has been developed to provide enhancements and benefits as described in greater detail herein with respect to alternative embodiments of the present invention.

One object of the present invention is to provide a viewer that reads image data from storage media, used with a digital camera or similar image recorder, and displays images on a screen built into the viewer.

Another object of the present invention is to provide a compact, portable and relatively lightweight digital image viewer resembling a conventional photo album. A digital photo album, according to the present invention, uses digital camera memory cards as image data storage components.

A further object of the present invention is to provide organized accommodation for a significant number of image data storage components, such as digital camera memory cards, within the housing of a digital image viewer. Effective organization of data storage components in a digital photo album according to the present invention could place literally hundreds and perhaps even thousands of digital records in a readily available condition for photo-viewing.

Yet another object of the present invention is to provide a visual display including an image viewing screen, such as a liquid crystal display (LCD) panel that is larger than most LCD panels incorporated into the body of digital cameras. Viewing of larger size images is more comfortable and convenient using a digital image viewer of the present invention.

As another object, a digital photo album in accordance with the present invention provides a self contained, battery-powered alternative to the use of a personal computer for displaying digital photographs. The digital viewer may include an input device, such as a compact keyboard or mouse, for managing software installed in the viewer for reading and displaying digital photographs. Also the portability of a digital image viewer according to the present invention overcomes a problem with many personal computers that are limited to a particular location and cannot readily be carried from office to living room, for example, for a more convenient and comfortable viewing experience.

Additionally, a digital viewer in accordance with the present invention is also useful for displaying books and/or magazines, which are stored on memory sticks. Through availability of an option for changing font and/or image size, those having sight problems will find benefit and usefulness from such a viewer.

Previously described objects of the present invention are accomplished using a digital image viewer having a size and appearance similar to a conventional photo album that normally contains individual images developed on sheets of photographic paper. A photo album containing several hundred photographs could be bulky and heavy. A digital image viewer, also referred to herein as a digital photo album, uses lightweight, high density data storage media that allows convenient access to possibly thousands of digital photos.

The present invention provides an electronic device as an image viewer or digital photo-album that contains a microprocessor to read digital camera memory cards and thereafter display photo-images based on data stored by the memory cards. Preferably the photo-album uses existing technology to provide a portable and relatively light weight device in a compact case made of plastic, or a similar durable construction material, that may be decorated to resemble a conventional photo-album.

An image viewer according to the present invention uses the same electronic components and processes that read and display digital photos on computer systems. However, a device dedicated to function as an image viewer or photo-album offers an alternative to a computer in the form of a less expensive, more portable device that may be carried from place to place and person to person for convenient and relaxed viewing of digital photographs. A viewer of this type provides an additional benefit that digital images may be viewed in sequence, as they were recorded. The device also eliminates the time consuming task of photo-printing and mounting of photographs in a conventional photo-album.

In one embodiment, the present invention includes a housing that has a recessed lid hingedly attached to a base shaped to provide an internal cavity. The cavity contains a digital memory card reader connected to a microprocessor that includes a memory module for software enabling the reading of image data. The microprocessor has a connection to a display, preferably a liquid crystal display (LCD), included in the recessed lid as a viewing screen for photographic images. A compact keyboard, positioned in the cavity of the base, addresses the microprocessor to use the features of the software to select and manipulate digital images displayed on the LCD screen. The digital image viewer operates on battery power, preferably using a rechargeable battery stored in the base cavity. A cover encloses the microprocessor, keyboard and battery in the base of the viewer housing, leaving an opening for the keys of the keyboard, which are needed for managing the microprocessor.

More particularly, the present invention provides a self-contained, portable digital image viewing apparatus, comprising a first housing and a second housing movably attached to the first housing, wherein the first housing is movable between an open position and a closed position with respect to the second housing. The apparatus includes a visual display mounted on the first housing, a user input mounted on the second housing and a plurality of digital storage media receptacles provided in a surface of at least the second housing.

These and other objects, embodiments advantages and/or distinctions of the present invention will become readily apparent upon further review of the following specification and associated drawings.

### BRIEF DESCRIPTION OF THE DRAWINGS

The invention will now be described in greater detail in the following way of example only and with reference to the attached drawings, in which:

FIG. 1 is a perspective view of a digital image viewer according to the present invention.

FIG. 2 is a detail section of a side elevation illustrating a memory card reader slot and a connection point to supply external power to a digital image viewer according to the present invention.

FIG. 3 provides a perspective view of the viewer of FIG. 1 in its closed configuration.

### DETAILED DESCRIPTION OF THE DRAWING FIGURES

Detailed embodiments of the present invention are disclosed herein; although it is to be understood that the disclosed embodiments are merely exemplary of the invention. Drawings for describing the invention are not necessarily to scale. Some features of the figures may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

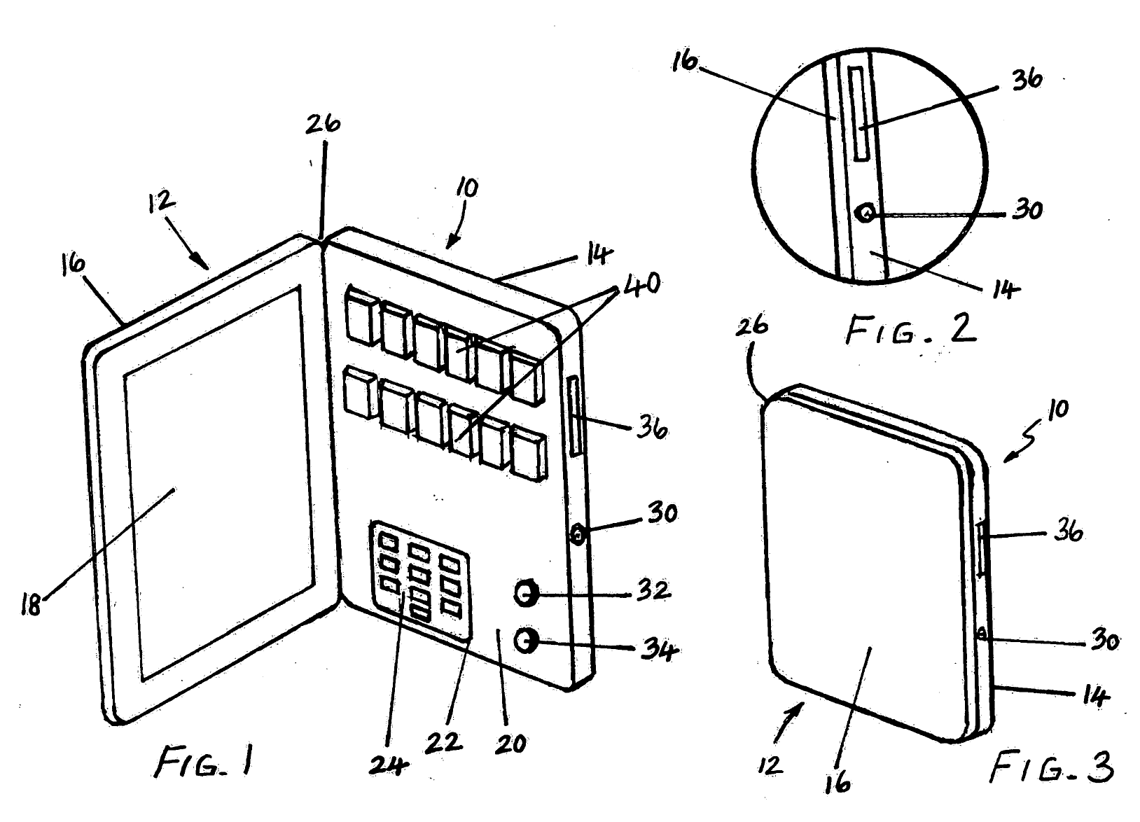

Referring to the figures, wherein like numbers refer to like parts throughout the several views, FIG. 1 shows a perspective view of a digital image viewer 10 according to the present invention. The embodiment of the viewer 10 shown in FIG. 1 includes a hinged enclosure 12 comprising a first housing 14 pivotally attached to a second housing 16 containing visual display 18, including a flat screen that may also be referred to herein as a liquid crystal display (LCD). A cover 20 of the first housing 14 encloses a digital information processing system (not shown) and a power supply (not shown) in a cavity in the first housing 14. The digital information system comprises components configured to access, interpret and process digital image data for display via the visual display 18. Suitable information processing components include a microprocessor and a memory module. Power supplies include batteries, other rechargeable power sources and the like to supply power to the digital image viewer 10.

The cover 20 has an opening 22 for a user interface that is illustrated as a keyboard 24 in FIG. 1. In an alternative embodiment to the depicted embodiment of the user interface or input device, the keyboard 24 has a different configuration to a standard computer keyboard having larger, circular shaped keys and only enough keys to operate the viewer 10 for viewing digital photographs. A portion of the keyboard 24 resides inside the cavity of the first housing 14 under the cover 20.

A hinge 26 connects the second housing 16 to the first housing 14 to provide an enclosure 12 that may be generally described as hingedly connected, substantially flat panels that fold together for compact storage and unfold to reveal the visual display 18 and keyboard 24. The hinge 26 may include a release mechanism allowing separation of the visual display 18 from the first housing 14 or allowing separation of the first housing 14 from the second housing 16. This release mechanism facilitates sharing of the visual display 18 among a group of people when the visual display 18 includes, for example, a retractable cord connecting it to the microprocessor located in the cavity of the first housing 14 or a wireless transceiver apparatuses suitably integrated for facilitating transmission of signals to and reception of signals by the visual display 18. The digital image viewer 10 includes a memory module that has image selecting and manipulation software installed for access by the keyboard 24 of the digital image viewer 10.

Referring to FIG. 1 and FIG. 2, the first housing 14 of the viewer 10 may include a control switch for supply of power from the power supply to energize parts of the digital image viewer 10, including the visual display 18 and the microprocessor. Preferably the power supply is a rechargeable battery pack that has connection to an external source of electricity through a power input port 30. As illustrated in FIG. 1, the control switch includes an on-button 32 and an off-button 34. Alternative means for switching power to a digital image viewer according to the present invention include toggle switches or pressure operated micro-switches that open and close, with unfolding and folding of the hinged enclosure 12, respectively, for power-up or power-down of the viewer unit 10.

Supply of electrical power from the power source, typically a battery, causes operation of the visual display 18 and the microprocessor, placing them in a condition for processing image data stored on suitable storage components, such as digital camera memory cards. In the current embodiment of the present invention the first housing 14 includes a card reader accessible by the card reader slot 36. While the present embodiment of a digital image viewer 10 exemplifies the use of memory cards, also referred to as memory sticks, it is also possible to use other forms of data storage media including high-capacity compact disks, portable hard drives, exemplified by “Microdrive,” available from IBM Corporation, and the like.

FIG. 1 shows that the first housing 14 of a digital image viewer 10 according to the present invention includes a number of organizing retainers 40, also referred to herein as receptacles, attached to the cover 20. The receptacles 40 in FIG. 1 appear as digital storage media receptacles having the shape of pockets for holding memory cards. It will be appreciated that memory card storage may use retaining means other than pockets 40. Other exemplary retainer means include clips, hooks, and slots and other attachment structures that provide temporary connection of one item to another.

Data storage components, such as memory cards, store image data suitable for access using the keyboard 24 user interface input device. Under operator control, the input device 24 manages the microprocessor unit for selecting and manipulating digital images for display on the visual display 18. Image data may be processed using microprocessor units and software known to one of ordinary skill in the art.

The keyboard 24, which is used to control the software associated with the microprocessor, preferably is compact in size and designed specifically to operate the components of the digital image viewer 10 that produces a visible photo-image on the visual display 18, which is preferably a liquid crystal display. Terms including screen, flat screen, visual display, liquid crystal display and liquid crystal display monitor and the like are used herein interchangeably in reference to the portion of the viewer 10 that displays photo-images retrieved from digital image media.

FIG. 3 shows a digital image viewer 10 according to the present invention in its closed condition. The panels of the hinged enclosure 12, represented by the first housing 14 and the second housing 16, may be covered by a variety of decorative materials to provide the appearance of a book or album, particularly a photo-album since the digital image viewer 10 is similar to a conventional photo-album as a convenient means for organizing and viewing photographic images. While a conventional photo-album organizes a number of individual photographs, a digital image viewer according to the present invention provides organizing retainers or receptacles 40 for storage components e.g. memory cards that offer access to possibly thousands of images that would require a conventional photo-album of such bulk that it would be difficult to handle.

As described, a digital image viewer 10 according to the present invention provides an apparatus of convenient size, weight and functionality so that viewing of photo-images is a straightforward task. After deciding which memory card, or other data storage component, to use for picture generation, an operator simply energizes the viewer 10, by activating the on-button 32, inserts the selected data storage component into the reader slot 36 then completes one or more key strokes to direct the microprocessor to convert selected image data into a photo-image viewable on the visual display 18. Options for manipulating the image depend upon the functionality of software selected from readily available digital photography applications. For example, photographic image manipulation may include adjustment of image properties such as size, color balance, brightness, contrast and the like. Alternatively, photo-presentation may be changed by combining several images in a single frame or grouping a number of selected images that may, for example, represent common subject matter. Regardless of changes in properties and presentation of photographic images, the digital image viewer is a conveniently portable means for displaying sharp photo-images to one or several people using a wide-angle screen. An image viewing session comes to an end by first closing the image selection and manipulation program then removing the memory card from the reader slot 36 and pressing the off-button 34.

In one embodiment of the present invention, the housings (12, 14) of the hinged enclosure 12 would be produced from any of a number of known durable, strong materials such as metals and high-impact plastics, including static-resistant plastic materials. In a preferred embodiment the enclosure 12 has a length of about 12 inches, a width of about 10 inches and is about 0.5 inch to 1.0 inch thick. The visual display 18 of the digital image viewer could be a rectangular LCD screen measuring about 10 inches in height and about 8 inches in width.

Another embodiment of the present invention includes housings (14, 16) that are decorated with materials of cloth or plastic to resemble a conventional photo-album. These materials could be further decorated with symbols and legends that may be applied to give an embossed appearance.

Yet another embodiment of a portable digital photo album 10 according to the present invention includes a printer port to allow transfer of images from the visual display 18 to a printer such as an inkjet or laser printer, for printing of hard copy of the images.

Plastic components used in various parts of the digital image viewer 10 (e.g. the enclosure 12) may be formed using molding techniques known to a person of ordinary skill in the art. Suitable processes include injection molding and blow molding.

A portable digital photo-album in accordance with to the present invention is adaptable to a variety of embodiments that provide for viewing of personal still photographs, or MPG movies or books that could be digitized for storage on memory cards. An optional zoom feature could aid image and text viewing by people who are visually impaired and availability of more than one reader port would allow creation of a photo-composition while selecting photo-images from multiple memory cards. A digital image viewer as described could be a useful tool in a number of business activities to visually demonstrate advantages of products and services.

A viewer in accordance with the present invention is configurable for facilitating copying of digital information from one memory card to another. For example, to facilitate such replication functionality digital information (i.e., a file) is accessed from a first memory card in the card reader slot of the viewer and temporarily stored to memory of the viewer. Upon removal of the first memory card from the card reader slot and insertion of a second memory card in the card reader slot, the digital information is copied onto the second storage card. In this manner, the viewer facilitates copying of digital information such as for sharing and/or distribution such digital information.

It is disclosed herein that a digital image viewer in accordance with the present invention is not limited to one type of digital storage media format. For example, the digital image viewer is capable of being configured for use with memory cards, MP3 disks, compact disks, digital video disks or a combination thereof. Furthermore, digital image reading functionality and viewing functionality may be implemented internally (as depicted herein) or at least partially externally via an input/output interface for connection to an external digital storage media access device (e.g., an MP3 player).

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of the present invention. To avoid unnecessary detail, the description omits certain information known to those skilled in the art. The preceding detailed description of digital image viewer and its components has been included herein to accentuate features of the device, which offers lower cost and improved portability compared to the personal computers and laptop computers usually required to view digital images recorded using digital cameras for example. It will be appreciated exemplary embodiments of the invention are not intended to be restrictive to the specific forms set forth herein, but on the contrary, it is intended to cover such alternatives, modifications, and equivalents, as can be reasonably included within the spirit and scope of the appended claims.

1. A self-contained, portable digital image viewing apparatus, comprising:
a first housing;
a second housing movably attached to the first housing, wherein the first housing is movable between an open position and a closed position with respect to the second housing;
a visual display mounted on the second housing;
a user input mounted on the first housing; and
a plurality of digital storage media receptacles provided in a surface of at least the first housing.

2. The apparatus of claim 1, wherein the first housing has a cavity and the second housing has a recess for retention of the visual display.

3. The apparatus of claim 2, wherein the visual display includes an image viewing screen.

4. The apparatus of claim 3, wherein the image viewing screen is a liquid crystal display screen.

5. The apparatus of claim 1, wherein the user input is selected from the group consisting of a keyboard and a mouse.

6. The apparatus of claim 1, further including a power supply.

7. The apparatus of claim 1, further including a reader for digital storage media held in the digital storage media receptacles.

8. A self-contained, portable digital image viewing apparatus, comprising:
a first housing having a cavity;
a second housing movably attached to the first housing, wherein the first housing is movable between an open position and a closed position with respect to the second housing that has a recess therein;
a image viewing screen mounted in the recess of the second housing;
a user input mounted on the first housing, the user input selected from the group consisting of a keyboard and a mouse;
a power supply;
a plurality of digital storage media receptacles provided in a surface of at least the first housing and
a reader of data from digital storage media held in the digital storage media receptacles.

9. An apparatus for viewing a digital image from a data storage component, the apparatus comprising:
an enclosure including a first housing and a second housing;
a liquid crystal display sized for retention in the second housing of the enclosure;
a microprocessor, in the first housing, having an electronic connection to the liquid crystal display;
a memory module having software installed therein;
a reader to receive the data storage component for transfer of digital image data from the data storage component to the microprocessor for display of the digital image on the liquid crystal display;
a power supply connected to the liquid crystal display and the microprocessor to provide power thereto;
an input device connected to the microprocessor to address the software installed in the memory module for selection and manipulation of the digital image;
a cover enclosing the microprocessor and the power supply in the first housing, the cover including an opening to expose the input device for operator access, the cover further including a plurality of retainers for organizing a plurality of the data storage components; and
a hinge connecting the second housing to the first housing of the enclosure for rotation of the second housing between a closed position and an open position.

10. The apparatus of claim 9, wherein the first housing has a cavity and the second housing has a recess for retention of the liquid crystal display.

11. The apparatus of claim 9, wherein the reader includes an entry opening to an end of the first housing, the reader having connection to the microprocessor, the entry having a size sufficient to accommodate the data storage component.

12. The apparatus of claim 9, wherein the data storage component is a digital camera memory card.

13. The apparatus of claim 9, wherein the input device is selected from the group consisting of a keyboard and a mouse.

14. The apparatus of claim 13, wherein the input device resides within a space in the cavity of the first housing such that keys of the keyboard protrude from the opening in the cover.

15. The apparatus of claim 9, wherein the cover has an upper surface and a lower surface that is attached to the first housing, the plurality of retainers being distributed on the upper surface of the cover.

16. The apparatus of claim 9, wherein the liquid crystal display lies adjacent to the input device, when the second housing is in the closed position, and the input device is available for operator access, and the liquid crystal display is viewable when the second housing is in the an open position.

17. The apparatus of claim 9, further including a power switch having an on-button activated to supply power from the power supply while viewing the digital image, the power switch having an off-button to terminate the supply of power to the apparatus.

18. The apparatus of claim 9 wherein:
the first housing has a cavity and the second housing has a recess for retention of the liquid crystal display;
the reader includes an entry opening to an end of the first housing, the reader having connection to the microprocessor, the entry having a size sufficient to accommodate the data storage component;
the data storage component is a digital camera memory card;
the input device is selected from the group consisting of a keyboard and a mouse;
the input device resides within a space in the cavity of the first housing such that keys of the keyboard protrude from the opening in the cover;
the cover has an upper surface and a lower surface that is attached to the first housing, the plurality of retainers being distributed on the upper surface of the cover; and
the liquid crystal display lies adjacent to the input device, when the second housing is in the closed position, and the input device is available for operator access, and the liquid crystal display is viewable when the second housing is in the an open position.
